(19) United States
(12) Patent Application Publication
(10) Pub. No.: US 2009/0173396 A1
(43) Pub. Date: Jul. 9, 2009

(54) ONE PIECE PLUMBING VENT, DRAIN PIPE

(76) Inventor: Mario Spadavecchia, Bronson, FL (US)

Correspondence Address: Clements Bernard PLLC, 1901 Roxborough Road, Suite 300, Charlotte, NC, 28211, US

(21) Appl. No.: 11/970,819

(22) Filed: Jan. 8, 2008

(51) Int. Cl. F16L 9/00; F17D 1/08; E03C 1/122

(52) U.S. Cl. 137/357; 138/178

(57) ABSTRACT

The invention relates to a unitary, one piece plumbing pipe for use as a drain and vent pipe. In particular, the invention can be used to drain a single appliance using the typical goose-neck style drain pipe, but it can also vent an entire plumbing system. The one-piece plumbing vent and drain pipe is quicker to install and replaces many pieces of pipe with a single piece pipe. Furthermore, no vent through the roof of a building is necessary in view of the present invention. The vent pipe has a vertical portion extending upwardly above the highest point of said drainage plumbing, but not through said building to the outside, said vent pipe having an opening capable of permitting ambient air to enter the pipe when there is negative fluid pressure within said pipe, but not permitting any fluid to escape the vent pipe when there is positive fluid pressure within said pipe.

### 1) FIELD OF THE INVENTION

The invention relates to a unitary, one piece plumbing pipe for use as a drain and vent pipe. In particular, the invention can be used to drain a single appliance using the typical goose-neck style drain pipe, but it can also vent an entire plumbing system. In a preferred embodiment, the vent and drain pipe can be part of the drainage system for a sink, but can vent every plumbing appliance in a bathroom, for example. The one-piece plumbing vent and drain pipe is quicker to install and replaces many pieces of pipe with a single piece pipe. Furthermore, no vent through the roof of a building is necessary in view of the present invention as the invention vent the drain pipe in the vanity of a sink cabinet, for example.

### 2) BACKGROUND

In a conventional plumbing system, the drain line from a shower, bath tub, toilet and/or sink are in fluid communication with a vent pipe that typically terminates above the roof of a building. This requires that a hole, roughly matching the diameter of the vent pipe, be drilled in the roof so that the plumbing system vents to the sky. Such a system is shown in FIG. 1. The conventional vent pipe is typically fluidly communicating with the drain pipe of a sink. Many pieces of pipe and pipe fittings are necessary to plumb the system.

Recently, a vent one way check valve has been patented that makes it possible to cap the conventional vent pipe to keep critters out. U.S. Pat. No. 7,270,146 to Johnston et al issued on Sep. 18, 2007 and is hereby incorporated by reference. This vent cap allows air to be drawn into the vent pipe, when there is a negative pressure, but does not allow any gasses or odors to escape the vent pipe, when there is a positive pressure. In essence, the vent cap is a one way check valve that allows the air to enter the drain pipe, but does not allow any fluid in the plumbing system to escape through the vent cap.

Fluid as used in this application means air (gas) or liquid (aqueous based liquids) or both. Thus if the drainage system is under positive pressure, neither liquid or gas based fluid can escape the vent pipe.

In construction of residential and commercial buildings, a vent pipe extending through the roof that opens to the atmosphere suffers a cost disadvantage in that the vent pipe typically is positioned within an inside wall and then projects through the roof thus marring the overall appearance of the roof. Furthermore the projection through the roof may cause potential leaks in the roof, when the sheath around the vent pipe is improperly installed.

There is a need in the plumbing business to reduce costs, to provide for an effective plumbing system, and to improve the overall appearance of the house by eliminating the vent pipe projecting through the roof. There is a need in the plumbing business to eliminate measuring, cutting and gluing many pieces of pipe to create a unitary combination drain and vent pipe.

### SUMMARY OF THE INVENTION

The invention eliminates many pieces of pipe and fittings that heretofore were necessary to create a vent pipe and particularly a one piece vent pipe that is also a drain pipe. Most preferably the one piece vent and drain pipe is adapted to be inserted at the highest point of a plumbing system. Generally the highest point is a sink. The one piece vent and drain pipe has a substantially vertical portion and a substantially horizontal portion, wherein the horizontal portion has one end connected to the drainage system and the other end is adapted to connect to the goose neck of the sink. The vertical portion extends upwardly, when in a plumbing system, from the horizontal portion.

In the broadest sense, the invention concerns a plumbing system in a building, comprising a vent pipe and drainage plumbing, said vent pipe in fluid communication with said drainage plumbing, said drainage plumbing draining one or more appliances selected form the class of sinks, toilets, bathtubs, showers, drains, wash machines, and dishwashers, said vent pipe having a vertical portion extending upwardly above the highest point of said drainage plumbing, but not through said building to the outside, said vent pipe having an opening capable of permitting ambient air to enter the pipe when there is negative fluid pressure within said pipe, but not permitting any fluid to escape the vent pipe when there is positive fluid pressure within said pipe.

In the broadest sense, the present invention comprises a vent and drain pipe for a sink, said pipe, when properly positioned in a building, having a horizontal portion and a vertical portion extending upwardly from said horizontal portion, said vertical portion terminating in an air vent capable of permitting ambient air to enter the pipe when there is negative fluid pressure within said pipe, but not permitting any fluid to escape said pipe when there is positive fluid pressure within said pipe, said horizontal portion having an end adapted to connect to a goose-neck drain of said sink.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of a conventional drain plumbing system (prior art) for a sink in a building;

FIG. 2 is a side perspective view of the vent drain pipe invention incorporated in a plumbing system for a sink;

FIG. 3 is a perspective view of a drainage system for a bathroom having a tub, a toilet, and a sink, with the vent drain pipe of the present invention; and

FIG. 4 is a side view of the vent drain pipe invention incorporated in a plumbing system for a sink.

The drawings are provided to assist one in understanding the invention, but they are not submitted to expand the scope of the claims.

### DESCRIPTION OF THE INVENTION

Drain pipes in buildings are typically made from PVC pipe because it comes in a variety of diameters and lengths, is easy to cut, and clues together in about 2 to 3 minutes. Accordingly the preferred raw material of the vent and drain pipe of the present invention is PVC pipe, although the present invention is also applicable to other materials such as copper pipe or other plastic based pipes. Typical drain pipes are 1¼ or 1½ inch diameter pipes. However any size pipe is suitable provided it is capable of adequately draining the bathroom or kitchen appliances, for example.

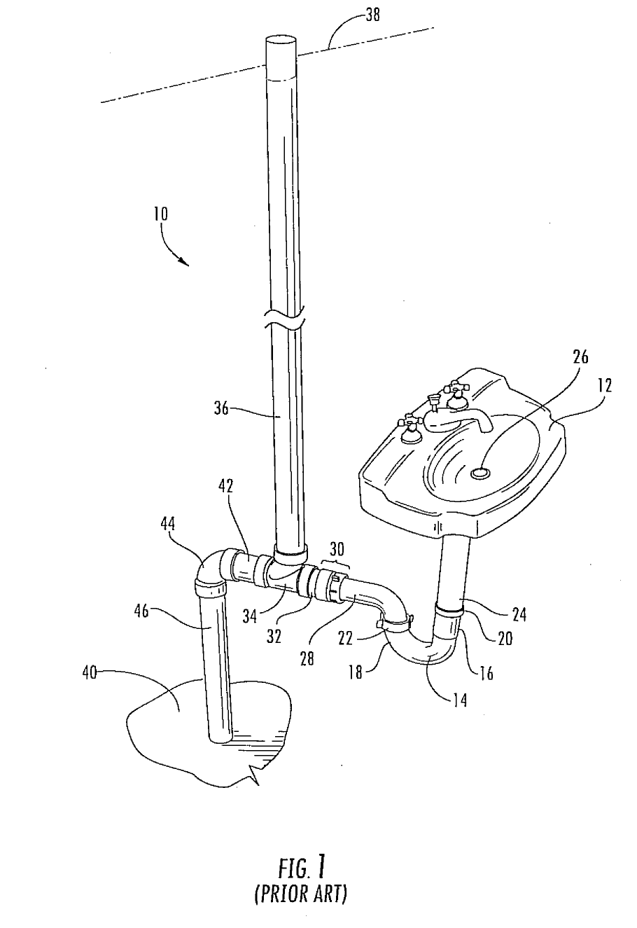

As shown in FIG. 1, the typical conventional prior drainage system illustrated shows generally a drain system 10 for a sink 12. The drain system 10 encompasses piping that includes a typical gooseneck 14; that has an upper end 16 and a lower end 18. The upper end has a screw joint 20 and the lower end has a screw joint 22. Unscrewing both screw joints 20 and 22 allows the gooseneck to be removed from the drain piping. A pipe 24 attaches to the drain opening 26 of the sink 12 and to the upper end 16 of the gooseneck 14. Pipe 28 attached to the lower end 18 of the gooseneck by means of screw threads (not shown) and attached to the drain system by means of an adjustable coupling 30. A pipe 32 connects with the coupling 30 and to an inverted T-joint 34. The T-joint 34 has an air vent pipe 36 extending through the roof 38 of the building, thus venting to the outside atmosphere. The vent pipe is generally hidden in an interior wall such that it is not visible in the interior of the building. However it is visible from outside of the building and particularly on slanted roofs. For this reason, most builders project the vent pipe through the roof on the back side of the building, so that it is not seen when viewing the front of the building.

At some point the drain pipe drops downwardly to drain the waste from the appliances and to the sewage system (either an individual septic field, or a community sewage treatment facility, or a city sewage treatment facility). Thus the drainage system has one or more vertical sections and one or more horizontal portions of pipe and couplings of various types. In FIG. 1, the horizontal portion is comprised of items 28, 30, 32, 34, and 42. Generally one of the vertical sections of pipe drops through and below a floor 40. There is a connecting pipe 42 that attaches to the inverted T-joint 34. The other end of pipe 42 attaches to the 90 degree coupling 44, thus causing the drainage system to flow from the horizontal to the vertical. Pipe 46 drains the system through the floor 40 and below. The vertical portions of the drain system are represented by pipe 24, 36, and 46. Typically all the pipes mentioned are hidden from view by means of a cabinet that the sink rests in, or by a wall, or floor.

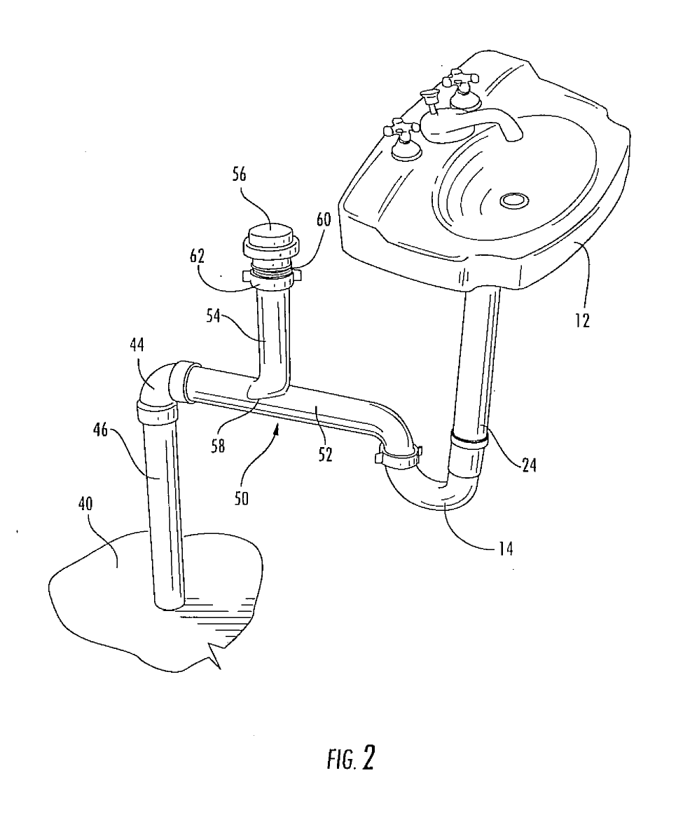

In FIG. 2, there is illustrated a sink 12, pipes or couplings represented by items 24, 14, 44, and 46. However items 28, 30, 32, 34, and 42 have now been replaced with the vent and drain pipe 50 of the present invention, represented by a horizontal pipe portion 52 and a vertical pipe portion 54. Vertical pipe portion 54 terminates in a vent cap 56 much like that disclosed in U.S. Pat. No. 7,270,146 to Johnston et al, which is hereby incorporated by reference. Where the vertical pipe 54 terminates into horizontal pipe 52, it does so by smoothly and gradually changing from the vertical into the horizontal at roughly a 45 degree angle at 58. This encourages the flow of the waste toward the outlet end where the drain system connects to the sewage system (either an individual septic field, or a community sewage treatment facility, or a city sewage treatment facility). The vertical pipe portion 54 terminates in a movable threaded ring 62. The vent cap 56 has screw threads 60 that are adapted to communicate with the threads of the ring 62 to tightly secure the vent cap 56 to the vertical pipe 54. Optionally, the vertical pipe 54 may merely terminate in a straight pipe (not shown), that is adapted to fit into the vent cap 56 (or the vent cap fit into the interior of the straight pipe end); or the vertical pipe 54 may terminate in exterior screw threads (not shown) and the vent cap 56 may have a interior threaded ring, like ring 62; or the vent cap 56 may have interior or exterior threads (not shown) adapted to communicate with the exterior/interior threads (not shown) on the upper end of the vertical pipe 54.

Vent and drain pipe 50 along with the vent cap 56 is designed to project upwardly, when properly positioned in the drain system 10, a distance of about 6 inches, such that the top of the sink has a higher elevation than the vent cap. In this manner the vent cap can fit within and be contained by the cabinet supporting and housing the sink. Of course it could extend higher than the sink, hidden by a wall. But placing it within the cabinet that supports the sink is easier, less expensive, and less time consuming. The vent and drain line is generally placed within the highest portion of the drain system, such that the vertical pipe 54 is the highest pipe and the vent cap 56 is positioned at least about 6 inches higher than the horizontal portion of the drain pipe (28, 30, 32, 34, and 42), for example.

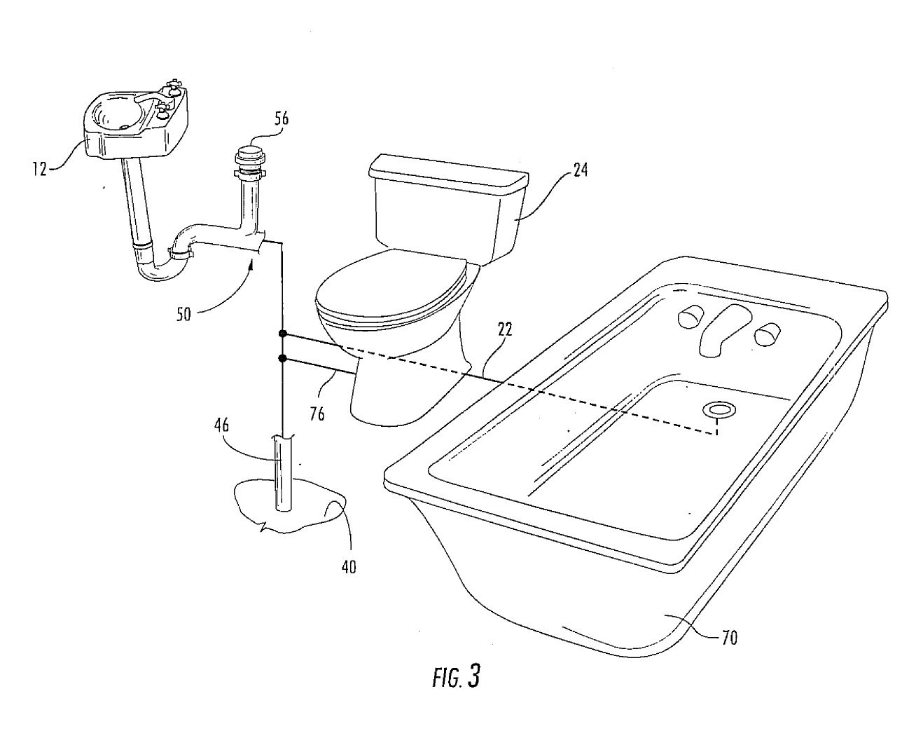

FIG. 3 illustrates a typical bathroom where the present invention vents all the appliances in the bathroom, such as a bath tub 70 that has a drain 72, a toilet 74 that has a drain 76, and a sink 12 having a drain system that includes the vent and drain pipe 50. In this case, the vent and drain pipe 50 can vent all the appliances by virtue of the fact that all the appliances are in fluid communication with one another.

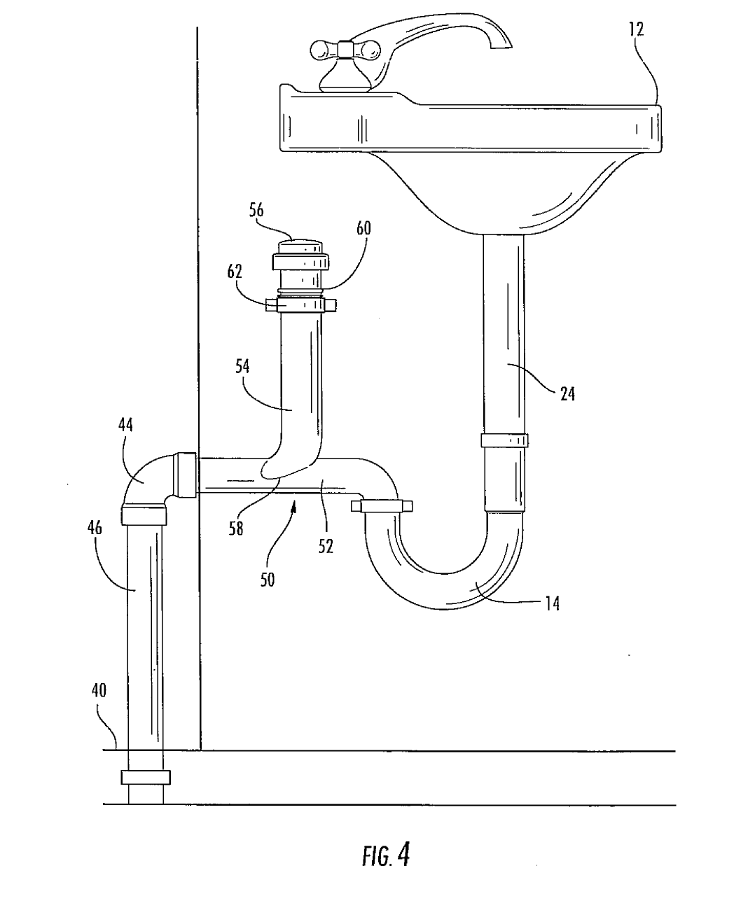

FIG. 4 shows a sink 12 and associated plumbing as shown in FIG. 2. FIG. 4 clearly shows that the vent cap 56 is about the same height as the drain 26 in the sink 12. The vent cap is clearly below the height of the top to the sink 12. Even thought the sink could be clogged and thus the water level in the sink may be higher than vent cap, the vent cap does not allow gas nor water to escape outwardly. Thus there is no fear that the vent pipe would soil any towels, for example, that might be placed within the cabinet supporting the sink. One end of vent pipe 50 extends into the wall and the pipe 46 drains through the floor 40.

In operation, when water is draining from the sink, toilet, or bath tub, the vent cap 56 functions by: if there is a negative pressure (created by flushing the toilet, for example) within the drain system, the vent cap opens allowing air to be sucked into the drain system, or if there is a positive pressure, the vent cap 56 does not allow any fluid from escaping for the drain system through the vent cap 56. Thus the vent cap, which terminated within the cabinet that supports the sink, does not allow water to escape the drain system and over flow the cap and dousing everything within the cabinet with waste water. Nor does it allow waste gas to escape the vent cap thus fouling the air in the bathroom, for example.

Thus it is apparent that there has been provided, in accordance with the invention, a vent and drain pipe that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications and variations as fall within the spirit and broad scope of the appended claims.

What is claimed is:

1) A plumbing system in a building, comprising a vent pipe and drainage plumbing, said vent pipe in fluid communication with said drainage plumbing, said drainage plumbing draining one or more appliances selected form the class of sinks, toilets, bathtubs, showers, drains, wash machines, and dishwashers, said vent pipe having a vertical portion extending upwardly above the highest point of said drainage plumbing, but not through said building to the outside, said vent pipe having an opening capable of permitting ambient air to enter the pipe when there is negative fluid pressure within said pipe, but not permitting any fluid to escape the vent pipe when there is positive fluid pressure within said pipe.

2) The plumbing system of claim 1, wherein said vent pipe terminates in a vent cap which is at least about 6 inches above said highest point.

3) The plumbing system of claim 1, wherein said vent pipe and said drainage plumbing are a unitary, one-piece construction.

4) The plumbing system of claim 3, wherein said drainage plumbing drains a sink, and said sink is said highest point of said drainage system.

5) The plumbing system of claim 4, wherein said drainage plumbing includes a portion adapted to be substantially horizontal, said horizontal portion intersecting with said vertical portion, said horizontal portion having an end adapted to connect to a goose-neck of said sink.

6) The plumbing system of claim 5, wherein said intersection of said horizontal and said vertical portions is curved so that said curve is directed away from said end adapted to connect to said goose-neck.

7) A vent and drain pipe for a sink, comprising, when properly positioned in a building, a horizontal portion and a vertical portion extending upwardly from said horizontal portion, said vertical portion terminating in an air vent capable of permitting ambient air to enter the pipe when there is negative fluid pressure within said pipe, but not permitting any fluid to escape said pipe when there is positive fluid pressure within said pipe, said horizontal portion having an end adapted to connect to a goose-neck drain of a sink.

8) The vent and drain pipe of claim 7, wherein the intersection of said horizontal and said vertical portions is curved so that said curve, when viewed transitioning from the vertical to the horizontal portions, is directed away from said end adapted to connect to said goose-neck.

9) The vent and drain pipe of claim 8, wherein said vertical portion terminates about 6 inches above said horizontal portion.

10) A plumbing system in a building, comprising a vent pipe and drainage plumbing, said vent pipe in fluid communication with said drainage plumbing, said drainage plumbing draining one or more appliances selected form the class of sinks, toilets, bathtubs, showers, drains, wash machines, and dishwashers, said vent pipe having a horizontal portion, one end of which is in fluid communication with an appliance, and having a vertical portion extending upwardly above said horizontal portion, but not through said building to the outside, said vent pipe having an opening capable of permitting ambient air to enter the pipe when there is negative fluid pressure within said pipe, but not permitting any fluid to escape the vent pipe when there is positive fluid pressure within said pipe.

11) The plumbing system of claim 10, wherein said vertical portion extends about 6 inches above said horizontal portion.

12) The plumbing system of claim 11, wherein said one end in fluid communication with an appliance is in communication with a sink.

13) The plumbing system of claim 12, wherein said sink has a goose-neck in said drainage plumbing and said one end is in communication with said goose-neck.

14) The plumbing system of claim 13, wherein the intersection of said horizontal and said vertical portions is curved so that said curve, when viewed transitioning from the vertical to the horizontal portions, is directed away from said one end in communication with said goose-neck.
